(19) United States
(12) Patent Application Publication
(10) Pub. No.: US 2023/0144159 A1
(43) Pub. Date: May 11, 2023

(54) AN APPARATUS TO EFFECT AT LEAST PARTIAL BREAKDOWN OF A MATERIAL OR PRODUCT ITEM OR A COMBINATION OF MATERIALS OR PRODUCT ITEMS

(71) Applicant: RDC TECHNOLOGIES LTD, Accrington Lancashire (GB)

(72) Inventors: John Norris, Blackburn Lancashire (GB); John Gerard Heffernan, Nelson Lancashire (GB)

(21) Appl. No.: 17/793,318

(22) PCT Filed: Jan. 15, 2021
(86) PCT No.: PCT/GB2021/050092

§ 371 Date: Jul. 15, 2022

(30) Foreign Application Priority Data
Jan. 16, 2020 (GB) 2000683.9

(51) Int. Cl. B01J 3/04; B09B 5/00; B09B 3/45

(52) U.S. Cl. CPC B01J 3/046; B09B 5/00; B09B 3/45; B01J 2219/00162

(57) ABSTRACT

An apparatus to effect at least partial breakdown of a discrete material or product item or a combination of discrete material or product items. The apparatus includes a treatment vessel in which the discrete material or product item or combination of discrete material or product items are located for treatment. There is at least one entry for introduction of at least one working fluid, at least one pressurisation arrangement to increase pressure on the material or product item or combination of material or product items within the treatment vessel. At least one decompression arrangement to rapidly reduce the pressure on the material or product item or combination of material or product items within the treatment vessel may also be provided. The at least one pressurisation arrangement and the at least one decompression arrangement are operable to cause repeated pressurisation and rapid decompression on the material or product item or combination of material or product items within the treatment vessel.

### TECHNICAL FIELD OF THE INVENTION

The present invention relates generally to apparatuses for the breakdown of materials and particularly to an apparatus to effect at least partial breakdown of a material or product item or a combination of material or product items.

### BACKGROUND TO THE INVENTION

In this sector, there are prior art apparatuses for processing material or product items.

U.S. Pat. No. 4,540,467 to Grube discloses a method and apparatus for the removal of mould core material from metal castings and for fragmentation of municipal material or material, e.g., paper products, which involves heating and hydrating the materials within a pressure vessel. Chemicals active on the material to be processed or hydration water are added during hydration to soften the material to be removed or fragmented. Excess liquid in the vessel is drained and pressurized steam is added for a selected period of time. A suitable temperature and pressure are achieved such that the moisture or liquid carried by the processed material will rapidly turn to steam or vapor when the pressure in the vessel is rapidly reduced by quickly opening an unloading means at the bottom of the pressure vessel. The sudden release of the pressure in the vessel causes the moisture to change to steam and a certain portion of the liquid in the material to flash to vapor in accordance with thermodynamic laws. The resulting rapid expansion within the processed material fragments it.

Some of the issues with this prior art method include, the preferred procedure requires a treatment of the material or material with an appropriate chemical reagent. Thus, this step involves an additional “wet treatment” of the material or and there is the attendant cost of the chemicals involved. Secondly, the single cycle of pressurisation and explosive decompression may produce less than optimum fragmentation. Thirdly, under the conditions proposed in the document, plastics articles remain intact and are not fragmented.

International Patent Publication No. WO2012107732 to Norris et al. is directed to a method for fragmenting a material or product comprising the steps of introducing said material or product item into a pressure vessel, subjecting said item or items to an atmosphere of superheated steam in the vessel of at least 0.5 bar above atmospheric pressure, subsequently decompressing the vessel to achieve a pressure reduction of at least 0.5 bar in at most 5 seconds, and repeating steps (b) and (c) to effect fragmentation of said material or product item or combination of material or product items.

The method in Norris et al. is based generally on treating a material or product item with at least two cycles of increased pressure, superheated steam and then decompression to reduce the pressure by at least 0.5 bar in at most 5 seconds, to effect fragmentation.

The theory posited in this document is that the discrete material or product items are fragmented by the steam and flash decompression due to one or more of melting, hydrolysis and thermal decompression.

It is an object of the present invention to at least partially overcome or ameliorate any one or more of the disadvantages of the prior art methods described above.

### SUMMARY OF THE INVENTION

According to the present invention there is provided an apparatus to effect at least partial breakdown of a material or product item or a combination of materials or product items, the apparatus comprising:
a) At least one treatment vessel in which the material or product item or combination of material or product items are located;
b) at least one entry into the at least one treatment vessel for introduction of at least one working fluid; and
c) at least one pressurisation arrangement to increase pressure on the material or product item or combination of material or product items within the at least one treatment vessel;

wherein the at least one pressurisation arrangement is operable to cause repeated pressurisation and depressurisation on the material or product item or combination of material or product items within the at least one treatment vessel.

According to another aspect of the present invention there is provided an apparatus to effect at least partial breakdown of a material or product item or a combination of material or product items, the apparatus comprising:
a) a treatment vessel into which the material or product item or combination of material or product items are located for treatment;
b) at least one entry into the treatment vessel for introduction of at least one working fluid;
c) at least one pressurisation arrangement to increase pressure on the material or product item or combination of material or product items within the treatment vessel; and
d) at least one depressurisation arrangement to rapidly reduce the pressure on the material or product item or combination of material or product items within the treatment vessel;

wherein the at least one pressurisation arrangement and the at least one depressurisation arrangement are operable to cause repeated pressurisation and rapid depressurisation on the material or product item or combination of material or product items within the treatment vessel.

Advantageously, the apparatus of the present invention can provide the rapid and controlled breakdown of material using pressure manipulation. The apparatus can be used to effect at least partial breakdown of a material or product item, a combination of material or product items which are the same type or of different types, or one or more material or product items which are embedded in or located on a carrier or useful product, preferably without any adverse effect on the carrier or useful product.

In an embodiment, the at least one treatment vessel may be temporarily sealed for treatment.

The at least one pressurisation arrangement may increase the pressure on the material or product item or combination of material or product items in the treatment vessel and/or within the treatment vessel.

The apparatus may function to remove or separate a material or product item from other materials, from a carrier or from one or more other useful products.

The apparatus of the present invention is directed towards the at least partial breakdown of a material or product item or combination thereof. The apparatus may be implemented in a fixed or portable configuration. In other words, a treatment chamber which is fixed in location may be used or, a treatment chamber which is portable may be used, depending upon the particular situation.

The at least one pressurisation arrangement (and at least one depressurisation arrangement, if provided) may be provided as a mechanism in the form of a mechanical or other device or in the form of a physical effect such as an increase (or decrease) in pressure caused by heating (or cooling) for example. The terms ‘mechanism’ and ‘arrangement’ are therefore used interchangeably in this description unless the context in which a term is used makes it clear that either a ‘mechanism’ of the broader ‘arrangement’ is intended.

The treatment chamber may be an external, pressure resistant casing of a product, such as for example, a filter casing. At least one pressurisation mechanism (and at least one depressurisation mechanism, if provided) can then be attached to the treatment chamber in order to cause the increase and reduction in pressure within the treatment vessel. In certain embodiments, the treatment chamber and/or vessel may be elongate. The treatment chamber and/or vessel may have any shape and any cross-sectional shape.

The apparatus may be implemented in a treatment chamber which is large or small. The apparatus may be used to treat a single material or item, multiple items of a single type or kind, or a combination of materials or of different types. The treatment of a single type of material in the same treatment will generally allow better targeting of the apparatus, in particular the operational parameters of the apparatus during the particular treatment regime to achieve a more efficient or more complete breakdown of the material.

Without wishing to be limited by theory, the apparatus of the present invention preferably acts to mechanically break down the material using agitation caused by pressure changes to disrupt the physical structure of the material. In some circumstances, dependent upon the nature of the process or working fluid used, chemical breakdown may also occur.

The breakdown of the material or product material will preferably achieve at least a size reduction and/or weakening of the structure of the material or product material and/or decomposition of the material or product material.

The operational parameters will typically be determined according to the material or product item or items to be treated and/or the material or mix if a combination of material or product items is treated.

The material or product item or items are preferably loaded into a treatment vessel in which the process takes place. The item or items can be loaded into the treatment vessel in any way.

The apparatus can be used to treat virtually any type of material or product item or items, typically physical material or such as bottles, general material or, household material or such as clothing and including difficult to treat material or such as nappies, sanitary napkins or sanitary towels and the like and even building material or such as carpet for example. The makeup of the material or product item or items will normally determine the makeup of the at least one working fluid and the specific parameters of the treatment regime.

The apparatus may be used to treat material on a batch basis or a continuous basis. In certain circumstances, a hybrid basis can be used, with a continuous series of batches being treated. Where the apparatus operates on a continuous basis, it is preferred that the material or product item or combination of materials or product items will have a particular residence time in the treatment chamber to effect at least partial breakdown.

In one continuous embodiment, a material to be treated (or a mixture containing one or more materials to be treated) can be introduced into a treatment vessel in the form of an elongate treatment vessel which may take the form of a duct, pipe, manifold or the like. The material to be treated (or a mixture containing one or more materials to be treated) is preferably conveyed through the treatment duct during treatment.

Pressurisation of the material to be treated (or a mixture containing one or more materials to be treated) may occur through the application of pressure using one or more inj ectors to create one or more zones of elevated pressure within the treatment duct in which pressurisation takes place and depressurisation occurs when the one or more injectors ceases to apply pressure and/or when the flow of material to be treated (or a mixture containing one or more materials to be treated) through the treatment duct moves the material to be treated (or a mixture containing one or more materials to be treated) out of the elevated pressure zone.

The pressure may be applied in one or more pulses through one or more injector. Multiple injectors may be provided radially or circumferentially about the treatment duct. Multiple injectors may be provided over the length of the treatment duct. High pressure working fluid may be introduced in pulse(s) via one or more injectors so as to rapidly pressurise a zone in the treatment duct. There may be multiple pulses from single phase injector(s) or multiple phases of injectors. Pressurisation may be achieved within the injector or prior to the injector feed. Depressurisation can be achieved as a result of absence of injector pulse.

The one or more injector may inject a combustible fluid such as hydrogen which, when mixed with another working fluid entering the inlet port and ignited results in a shock-wave and the creation of additional substances such as water vapour for example, which may form at least a part of the working fluid.

An injector may be provided substantially transverse to the direction of the flow through the treatment vessel, at an acute angle relative to the direction of the flow through the treatment vessel, in a counter current direction to the direction of the flow through the treatment vessel or at an angle relative to the counter current direction of the flow through the treatment vessel.

The number and configuration of inj ector(s) provide will depend on the treatment regime required. A ring of multiple injectors about the treatment duct can create a treatment zone through which the material must pass. Multiple rings over the length of the treatment vessel can form multiple treatment zones over the length of the treatment vessel.

One or more injectors can be provided in line within the treatment vessel. This can create a pulsejet configuration treatment vessel. In this configuration, treatment is intermittent, with the pressurisation and expulsion of each charge of working fluid or mixture preferably causing the intake of a fresh charge. The material or product to be treated may remain in position with the working fluid passing though the treatment vessel and/or any treated material exiting the vessel.

Provision of one or more injectors in a counter current direction to the direction of flow through the treatment vessel will typically increase the turbulence of the flow through the treatment vessel.

Any one or more injectors may take the form of a tap/valve/injector releasing pressure from an external generator/source/reservoir or may produce the pulse within the injector by mechanical/electro-mechanical/magnetic/piezoelectric/photoelectric/acoustic/ultrasonic/chemical/combustive means.

A low-pressure zone or vessel may be associated with an outlet of a treatment vessel. The low-pressure zone or vessel may be at or close to a vacuum.

If provided in an embodiment in which the at least one pressurisation mechanism and at least one depressurisation mechanism is attached or mounted to a pressure resistant casing to create a treatment chamber, the pressure resistant casing is preferably subjected to treatment for a particular treatment time to effect at least partial breakdown of material within the pressure resistant casing.

Use of the apparatus of the present invention may form useful products from the at least partial breakdown of the material or product item or items. Downstream processing of any product streams from the apparatus of the present invention may be undertaken to separate and/or recover any useful products formed.

Any stream exiting the apparatus of the present invention may be processed for recovery of the at least one working fluid, reprocessed using the same or alternative parameters or subject to further processing methods to separate, cleanse, purify or refine products of the process.

The apparatus of the present invention may include a treatment vessel into which the material or product item or combination of material or product items are located for treatment. The treatment vessel may have any configuration. Although the treatment vessel is to be subjected to pressure internally, the treatment vessel may be one which is not defined or characterised as a pressure vessel, particularly for the purposes of pressure vessel regulations. The treatment vessel may therefore be a pipe or similar for example. The treatment vessel may have any size.

Before entry to the treatment vessel, the material or product item or items may be subjected to one or more pre-treatment steps. It is particularly preferred that the material or product item or items undergo size reduction before treatment. Size reduction will typically lead to an increase in surface area per unit volume of the material or product item or items. Surface area of the material or product item or items will typically be an important factor in the efficacy of the treatment with a larger surface area generally leading to greater and/or faster breakdown. Any size reduction mechanism may be used but will typically be appropriate for the type of material or combination of types of material.

A mechanism may be provided, at least partially within the treatment vessel, to transport material or product to be treated into, through and/or out of the treatment vessel. For example, a screw conveyor, cable conveyor, chain conveyor, auger, or indexing mechanism may be provided. Preferably, any mechanism used will be able to be sealed in or to the treatment vessel.

In an embodiment, a conveyor may be provided to convey treated material out of a treatment vessel. A screw conveyor is preferred for this purpose. A screw conveyor can seal the exit from the treatment vessel through the formation of a plug of material in the screw conveyor. A screw conveyor may extend into the treatment vessel and may simply remove material. A screw conveyor may be provided through the treatment vessel which may allow the screw conveyor to convey material to be treated into the treatment vessel, support the material during treatment and then remove material from the treatment vessel. Preferably, if provided, a conveyor will be located in a lower portion of the treatment vessel but this would depend on the particular configuration.

One of the pre-treatment steps may be or include maceration. The liquid used will preferably depend on the composition of the material or to be treated.

One of the pre-treatment steps may be or include a liquid content reduction step.

A batch basis may be used. Alternatively, the apparatus may operate on a continuous basis or a hybrid (semi-continuous) basis. A semi-continuous basis may include the treatment of a number of batches sequentially. A treatment vessel may be provided in a cassette or similar configuration and cycled through a treatment regime before advancing to the next cassette or similar.

Pre-treatment may include subjecting the treatment volume to a number of preconditioning pressurisation steps to create optimum conditions.

The treatment vessel may be of a fixed working volume, at least while the treatment regime is underway. The treatment vessel may be a variable working volume vessel. The working volume of the treatment vessel will typically be adjustable in order to take account of the size of the charge of the material or product item or items and/or the type of material or to be treated. The working volume of the treatment vessel will preferably be adjusted prior to treatment, but be maintained as a fixed working volume while a particular treatment regime is underway.

The working volume may be adjusted dynamically during the treatment regime to achieve desired process conditions or to maintain the pressure range within the vessel by compensating for any reduction in material volume during the process.

Any mechanism of adjusting the working volume of the vessel may be used. A particularly preferred mechanism is the provision of a piston which is movable relative to the working volume of the treatment vessel in order to change the working volume. Preferably, the piston will be mounted relative to the treatment vessel using a threaded mount which has the advantage of being infinitely adjustable. Alternatively, the piston may be mounted using an incremental mounting system, allowing movement of the piston in increments relative to the treatment vessel.

Alternatives for adjusting the working volume include a ram driven in any way or a telescopic treatment chamber to allow the working volume to be adjusted.

The working volume adjustment piston will typically be provided least partially within the treatment vessel, typically defining one wall of the treatment vessel, or at least one wall of the working volume. The piston will typically be moved in the treatment vessel to reduce the working volume of the vessel. Reducing the working volume of the treatment vessel may allow higher pressures to be achieved within the treatment vessel. Still further, the size of the workpiece may be adjusted within a working volume (a larger workpiece in a given working volume may allow higher pressures to be achieved within the working volume).

Any material of construction can be used to form the treatment vessel. Typically, the treatment vessel will be manufactured from metal as a metal vessel will also have the advantage of being more resistant to temperature fluctuations which may be caused by the pressure changes (or friction) during the treatment regime. Other materials may be used for advantageous characteristics for example, one or more ceramic materials may be used as a coating or a construction material to overcome pressure/temperature/material breakdown issues and/or fouling

Preferably, the material or product item or items are located within the treatment vessel to allow the at least one working fluid access to multiple sides of the material or product. The material or product item or items will preferably be centrally located within the treatment vessel. The location of the material or product item or items may be dependent upon factors such as any standing wave and fluid velocity profile within the treatment vessel, the workpiece may need to be closer to one part of the treatment vessel than another for optimal treatment. The material or product to be treated may be provided in a location to maximise the pressure gradient to which the material or product is subjected or to facilitate desired fluid, particle and/or material movement.

The material or product item or items may be mounted in the vessel using a locating apparatus. For example, a mesh holder or similar may be provided. A perforated bed or similar may be provided at or towards a lower portion of the treatment vessel. If provided, a locating apparatus may be provided in any position within the treatment chamber to facilitate the breakdown process for the material being processed. The material or product item or items may be suspended within the treatment vessel.

In one embodiment, the material or product item or items may be sufficiently reduced in size that the at least one working fluid can be agitated within the treatment vessel to the point where the at least one working fluid fluidises the material or product item or items within the treatment vessel during the treatment regime.

The treatment vessel may be connected to an appropriate piping, ducting, gallery or manifold arrangement to allow recycling/reuse of at least part of the at least one working fluid and or products of the process.

The treatment vessel may be connected to allow a portion of the at least one working fluid to bypass part or all of the treatment vessel and or process and be connected to the outlet of the treatment vessel in order to utilise the Venturi effect or the Bernoulli principle to assist with the removal of the at least one working fluid and/or the at least partially treated material or product item or items from the treatment vessel. Any one or more devices or configurations may be used in the apparatus to accelerate/decelerate the working fluid at any one or more points in the fluid path.

Monitoring equipment is typically associated with the treatment vessel or working volume of the treatment vessel in order to monitor the efficacy of the treatment. Monitoring equipment will typically be provided to monitor conditions to control at least the temperature and pressure within the working volume.

Preferably, monitoring equipment may be provided to monitor the degree of destruction/breakdown of the material or to be treated. Monitoring equipment may be provided to monitor the degree of cleanliness of a substrate or carrier of the material or mixture to be treated. If the treatment regime is effective in fewer cycles than programmed, then the treatment regime may be cut short or ended early to save time and/or energy.

Typically, monitoring, sample testing or the use of one or more indicator devices may be used in real-time or post process, allowing adjustments to the treatment regime to be made if necessary.

Any monitoring, sampling or indicator equipment may be used to monitor the conditions within the treatment vessel, the outside of the treatment vessel and/or one or more exits from the treatment vessel.

The sealing of the treatment vessel may be accomplished in any way that is appropriate and at any time during the operational process that is appropriate. The particular time at which the treatment vessel sealed will normally depend on whether the treatment vessel was being operated on a batch or continuous basis. The treatment vessel which is being operated on a batch basis will typically be simpler to seal. The time at which the treatment vessel being operated on a batch basis is sealed will normally be either prior to introduction of the material or product item or items or thereafter but at least before the introduction of the at least one working fluid into the treatment vessel.

One or more ports may remain open to aid fluid flow and management of debris/separated components. Any one or more means of creating flow of material and/or working fluid in desired direction can be used such as an impellor, pump, fluid jet, pressurisation, gravity, or the like.

The apparatus of the present invention includes at least one entry into the treatment vessel for introduction of at least one working fluid. The at least one entry may be provided at any location relative to the treatment vessel. The at least one entry is typically sized to allow introduction of the at least one working fluid in an appropriate time period. The at least one entry may be or include an injection mechanism to inject the at least one working fluid into the treatment vessel.

The at least one entry may be associated with a bypass section to allow a portion of the at least one working fluid to bypass all or part of the treatment vessel and or process. Typically, the bypass will be associated with the at least one exit from the treatment vessel.

The at least one entry may be associated with at least one recycle stream in order to recycle a part of the at least one working fluid that has been used for treatment and which is recovered from an outlet.

Alternatively, at least one recycle stream may be associated with a working fluid reservoir.

The at least one entry may be associated with at least one reservoir of working fluid. The at least one entry may be associated with at least one generator for generating at least one working fluid.

Typically, a charge of at least one working fluid is introduced into the treatment vessel prior to initialisation of a treatment regime. The size of the charge of the at least one working fluid will typically depend upon the working volume of the treatment vessel and/or on the size of the charge of at least one material or item or items and/or the composition of the material or to be treated.

Additional working fluid(s) may be added to the treatment vessel over the course of the treatment regime. Any working fluid which is added during a treatment regime may be the same as or different to the working fluid added prior to the treatment regime beginning. A treatment regime may include different cycles using different working fluids or combinations of working fluids in order to effect the at least partial breakdown of the material or product item or items.

One or more inlets may be provided into the treatment vessel for the introduction of the at least one working fluid. The treatment vessel may include one or more exit for the working fluid.

In some embodiments, the at least one working fluid and the at least partially broken-down material or product item or items may be introduced into the treatment vessel together.

In some embodiments, the at least one working fluid and the at least partially broken-down material or product item or items may exit the treatment vessel together.

The exiting at least one working fluid may be spent or wasted or recycled or undergo further processing for recovery, (re)forming, recycling, repurposing or the like.

A separation step to separate the at least one working fluid exiting the treatment vessel from the at least partially broken-down material or product item or items may be provided before the at least one working fluid is spent or wasted or recycled.

It may be that useful by-products are formed in the treatment vessel due to the at least partial breakdown of the material or product item or items and if so, any useful by-products may be separated from any exit stream leaving the treatment vessel.

In some embodiments, an exit may be provided for the at least one working fluid and a separate exit provided for the at least partially broken-down material or product item or items exiting the treatment vessel.

The or each entry into the treatment vessel and the or each exit from the treatment vessel, particularly for the at least one working fluid would typically be located in the treatment vessel in order to allow the introduction of the working fluid to evacuate or purge the treated material or and/or working fluid from the treatment vessel. The or each entry and exit may be provided in a coaxial or any other arrangement which suits the components/materials.

As mentioned above, the treatment vessel may have an elongate configuration with an inlet at one end and an outlet at an opposite end with the material or product item or items and the at least one working fluid, entering the treatment vessel at one end and exiting the opposite end. The material or product item or items and the at least one working fluid may follow plug flow or turbulent mixing models in a pipe treatment vessel.

The apparatus of the present invention includes at least one pressurisation arrangement to increase the pressure within the treatment vessel. Preferably, the at least one pressurisation mechanism mechanically induces or causes the increase in pressure. In one embodiment, the pressure in the treatment vessel is increased by changing the effective working volume in the treatment vessel. The increase the pressure within the treatment vessel will normally cause the at least one working fluid pressure to increase.

The increase in pressure may be achieved using any appropriate way. Some pressurisation methods and apparatus may have synergistic effects that go beyond pressure increase. Mechanisms such as heating may be used to increase pressure.

Heating may have an additional synergistic effect of not only increasing the pressure but also heat treating of the material or product.

Heating may be used to augment the operation of the apparatus and/or as a primary mechanism to increase the pressure.

Heating may be provided in successive treatment vessels and/or zones. Heating may be provided repeatedly in a process vessel.

The decrease in pressure may be achieved using any appropriate way. Some depressurisation methods and apparatus may have synergistic effects that go beyond pressure decrease. Mechanisms such as cooling may be used to decrease pressure. Cooling may have an additional synergistic effect of not only decreasing the pressure but also treating of the material or product.

Cooling may be used to augment the operation of the apparatus and/or as a primary mechanism to decrease the pressure.

Cooling may be provided in successive treatment vessels and/or zones. Cooling may be provided repeatedly in a process vessel.

The at least one pressurisation mechanism may be associated with the at least one depressurisation mechanism. A single mechanism may be provided to cause both pressurisation and depressurisation.

One or more pressurisation mechanism may be provided.

In one embodiment, a movable piston may be associated with the treatment vessel to cause pressure increases within the working volume of the treatment vessel. The movable piston will preferably be located at least partially within or associated with the treatment vessel. The movable piston may be located within a secondary vessel associated with the treatment vessel to allow the moveable piston to cause pressure increases within the working volume of the treatment vessel.

The movable piston may be located within a secondary portion of the treatment vessel which is separated from a treatment portion of the treatment vessel into which the material or product item or items are located. When provided in this configuration, the secondary portion is typically associated with the treatment portion such that an increase in pressure in the secondary portion also causes an increase in pressure in the treatment portion.

Typically, the movable piston will be mechanically driven. Preferably, the movable piston will reciprocate causing the pressurisation and subsequent depressurisation in the treatment vessel.

The movable piston may be driven using any mechanism. The mechanism will preferably cause reciprocation of the movable piston.

In other forms the pressurisation and or depressurisation may be achieved using other compressors such as Wankel engines, Roots type Superchargers or the like.

In one form, a known mechanism such as an internal combustion engine for example, could be used to drive the movable piston. A mechanism such as an internal combustion engine may already include one or more movable pistons, the movement of which can be adapted to provide the cycles of pressurisation and subsequent depressurisation in the treatment vessel which are utilised by the apparatus of the present invention. If an internal combustion engine is used, the engine may have any number of compression chambers and be of any type, for example, in-line, V-configuration, radial or any type of rotary configuration.

The mechanism used to drive the movable piston or compression and or decompression device will preferably be used to define the parameters of the pressurisation and depressurisation stages of the repeatable cycle according to which the present invention operates. This pressurisation may also be adjusted/controlled by use of passive or active devices to operate/control forced induction, vacuum exhaust, ports, valves or variable volume chambers.

The or each treatment vessel may be sealed or at least partially sealed using a physical sealing device or member such as a valve for example. The or each treatment vessel may be sealed or at least partially sealed using a portion of the material to be treated to form a sealing ‘plug’. A portion of the material to be treated may be used in this way in relation to any one or more entry to the at least one treatment vessel and/or any one or more exit from the at least one treatment vessel.

A gas ‘plug’ may be used to seal or at least partially seal any one or more entry to the at least one treatment vessel and/or any one or more exit from the at least one treatment vessel. For example, back pressure could be used to prevent flow whilst pressure is applied.

The pressurisation and depressurisation stages will typically include operational parameters such as the duration of pressurisation, the duration of depressurisation (each of which respectively include both the overall time taken to pressurise and depressurise the treatment vessel as well as the speed or rate of pressurisation and depressurisation), the compression or pressurisation ratio, the depressurisation ratio and the like.

For example, the pressurisation stage may be longer in time than the depressurisation stage which will typically occur rapidly. The depressurisation stage will preferably be a flash or instantaneous depressurisation stage. The increase in pressure may take place over a period of time and then the pressure may be maintained at an elevated level for a period of time within the treatment vessel prior to depressurisation. Pressurisation may take place as a number of pressurisation steps. Each pressurisation step may include a decompression step. A decompression step following a pressurisation step may not be a flash or instantaneous depressurisation stage but merely a reduction is pressure followed by a further pressurisation step in order to build pressure prior to a flash or instantaneous depressurisation stage.

A control device will typically be provided to control the mechanism used to drive the at least one pressurisation and/or depressurisation mechanism.

The degree of pressurisation and decompression may be the same but implemented over a different time period.

One or more compression steps may be used. One or more decompression steps may be used.

At least one depressurisation mechanism may be provided to rapidly reduce the pressure in the treatment vessel to a pressure of above the starting pressure, that is, the depressurisation mechanism may reduce the pressure in the treatment vessel, but not as much as the immediately preceding increasing pressure.

The degree of pressurisation and depressurisation may differ. The degree of pressurisation and depressurisation may differ in different cycles across the treatment regime. For example, the degree of pressurisation in earlier cycles in a treatment regime may be less than the degree of pressurisation in later cycles, in order to build pressure in the treatment vessel and then the later cycles may reduce the pressure in the treatment vessel to a greater degree than the pressurisation in the immediately preceding pressurisation stage.

The at least one pressurisation mechanism will preferably increase the pressure within the treatment vessel by pressurising the at least one working fluid within the treatment vessel. Typically, when introduced, the at least one working fluid may displace (totally) any other atmosphere in the treatment vessel.

The increase in pressure within the treatment vessel may be a staged increase over a number of cycles, to a maximum treatment pressure, followed by a staged decrease in pressure over a number of cycles.

As mentioned above, the apparatus may include at least one depressurisation mechanism to rapidly reduce the pressure in the treatment vessel. A single depressurisation mechanism may be provided or more than one depressurisation mechanism may be provided.

Preferably, the depressurisation mechanism is integrated into or with the pressurisation mechanism.

Although the apparatus of the present invention will typically capture used working fluid exiting the treatment vessel for recycle and/or reuse, the depressurisation mechanism may include a valve or similar associated with the treatment vessel to allow venting of the treatment vessel to reduce the pressure. However, as the pressurisation and depressurisation stages are preferably repeated, the treatment vessel will preferably not be vented as this would typically cause loss of the at least one working fluid, which would then require replenishment and therefore increase the amount of the at least one working fluid which is used, if the at least one working fluid is not recovered as a part of the venting.

Preferably, the at least one depressurisation mechanism will operate to depressurise the treatment vessel using flash decompression or explosive decompression. The at least one depressurisation mechanism may operate more quickly or in a shorter time when compared to the pressurisation stage. It is preferred that the depressurisation stage is substantially instantaneous.

The depressurisation may occur at any rate. For example, the rate of depressurisation may be relatively slow, for example between 0.0001-0.1 bar per second. This rate may be advantageous if the treatment effect is achieved through the pressurisation of the material to be treated. Alternatively, the rate of depressurisation may be more rapid, such as for example, any one or more of:

0.001-1 bar per second or

0.001-1 bar per millisecond or

0.001-1 bar per microsecond or

0.001-1 bar per nanosecond or

0.001-1 bar per picosecond.

The more rapid the depressurisation stage, the more explosive the depressurisation which may cause a different effect on the material to be treated.

The apparatus of the present invention is typically operated such that the at least one pressurisation mechanism (and the at least one depressurisation mechanism, if provided) cause repeated pressurisation and subsequent rapid depressurisation within the treatment vessel in order to affect at least partial breakdown of the material or product item or items.

Preferably, the apparatus will be operated in a treatment regime to treat a particular charge of material or, with the treatment regime being made up of a plurality of cycles, each cycle being made up of a pressurisation stage and a subsequent rapid depressurisation stage. The number of cycles in the treatment regime will preferably be determined according to the material or which is introduced for treatment.

The controlling parameters of each pressurisation stage and each subsequent rapid depressurisation stage will normally be determined prior to commencement of the treatment regime. As mentioned above, the parameters of each pressurisation stage and/or each subsequent rapid depressurisation stage, of each cycle, may be the same or different.

The particular design of the individual stages and the cycles will generally be important to the efficacy (degree of breakdown) and/or efficiency (time used) of the treatment regime.

Conservation of energy mechanisms may be utilised to reduce the overall energy consumption of the apparatus.

An agitator may be provided in the treatment vessel or in association with the treatment vessel in order to agitate or circulate the at least one working fluid within the treatment vessel, particularly during the treatment regime. One or more agitation cycles may be used during a treatment regime. One or more purging cycles may be used during a treatment regime. One or more cleaning cycles may be used after a treatment regime.

The present invention utilises at least one working fluid. Typically, the at least one working fluid will be pressurised and depressurised within the treatment vessel.

The present invention may utilise any one or more working fluids.

In a preferred embodiment, the size of the charge of working fluid is adjusted to suit the size of the charge of the material or product item or combination of material or product items and/or the size of the treatment chamber.

The at least one working fluid could be gaseous, liquid or a mixture of phases. The at least one working fluid will preferably include a mixture of components. If a mixture of components is used, then the components need not be of the same phase. For example, a gaseous carrier may be used with a hybrid phase component such as steam.

The at least one working fluid may include at least one active component and at least one carrier.

Any type of at least one active component may be provided for example one or more reactants and/or one or more solvents may be provided with at least one carrier. The treatment may be enhanced or facilitated using one or more catalysts, which may be added at any point in the process, for example prior to the treatment commencing and/or part way through.

The at least one working fluid may be or incorporate atmospheric air with all of its components (including water vapour). The at least one working fluid may be or incorporate water.

The at least one working fluid may be or incorporate steam, or atmospheric air plus steam. Any percentage of water vapour may be used in the at least one working fluid. The working fluid may be or include refrigerant gasses such as HFCs and HFO.

The at least one working fluid may include one or more chemically volatile substances to complement and/or replace any one or more of the components.

The composition of the at least one working fluid will preferably be dependent upon the material or product item or combination of material or product items to be treated. For example, material or product items of materials based on organic components, such as plastic bottles for example, may be better treated by a working fluid which includes at least one organic component or organic solvent provided in an atmospheric air carrier.

If one or more components are used in the at least one working fluid, then one or more of the components may be recovered or removed from any exit stream(s).

The at least one working fluid may be introduced into the treatment vessel from a reservoir or from a working fluid generator or both. One or more balancing tanks may be provided. One or more charge tanks may be provided.

In one form, the at least one working fluid may be used in a bypass configuration to bypass part or all of the treatment vessel and/or process but be connected to an exit of the treatment vessel. The bypass configuration may be used to harness the Bernoulli principle or Venturi effect to assist with removal of the at least one working fluid and/or material or product item or combination of material or product items, from the treatment vessel. The volume of at least one working fluid in the feed compared to the volume in the bypass configuration is typically adjustable.

The at least one working fluid may be injected into the treatment vessel. Injection of the at least one working fluid may agitate the atmosphere in the treatment vessel. Injection of the at least one working fluid prior to treatment may act to purge any existing atmosphere from the treatment vessel.

The working fluid exit stream and/or at least partially broken-down material or product item exit stream may be treated to recover the at least one working fluid and/or any material that can be used to generate or complement the at least one working fluid.

One or more mixers may be provided to mix the at least one working fluid as required prior to introduction.

The apparatus of the present invention may be used on a material or item or items or alternatively may be used on a substrate or carrier which has material or on or in the substrate or carrier. The operation of the apparatus may have little or no adverse effect on the substrate or carrier. Alternatively, the operation of the apparatus may effect at least partial breakdown of the substrate or carrier in order to release the material on the substrate or carrier.

In some circumstances, a substrate or carrier may be chosen for the material or to be treated, to suit or enhance the effectiveness of the breakdown of the material or to be treated.

A pre-treatment step may include dehydration of the material.

A pre-treatment step may include pre-soaking the material and/or product to be treated in at least one working fluid.

One or more post-treatment apparatus may be provided to capture and/or separate any one or more components, typically useful components from any stream exiting the treatment vessel.

### DETAILED DESCRIPTION OF THE INVENTION

In order that the invention may be more clearly understood one or more embodiments thereof will now be described, by way of example only, with reference to the accompanying drawings, of which:

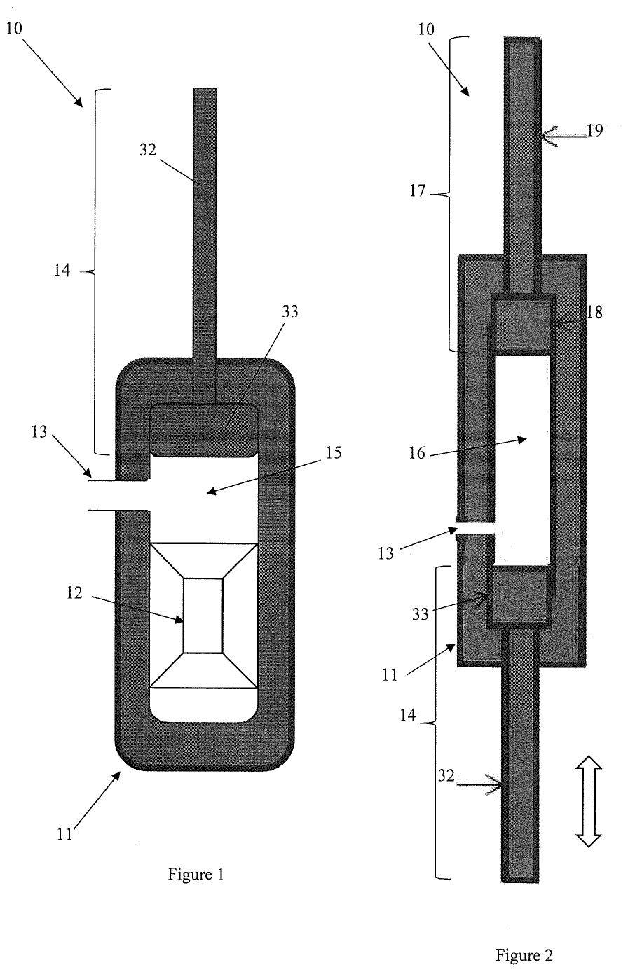

FIG. 1 is a schematic sectional side view of an apparatus according to a first embodiment.

FIG. 2 is a schematic sectional side view of an apparatus according to a second embodiment.

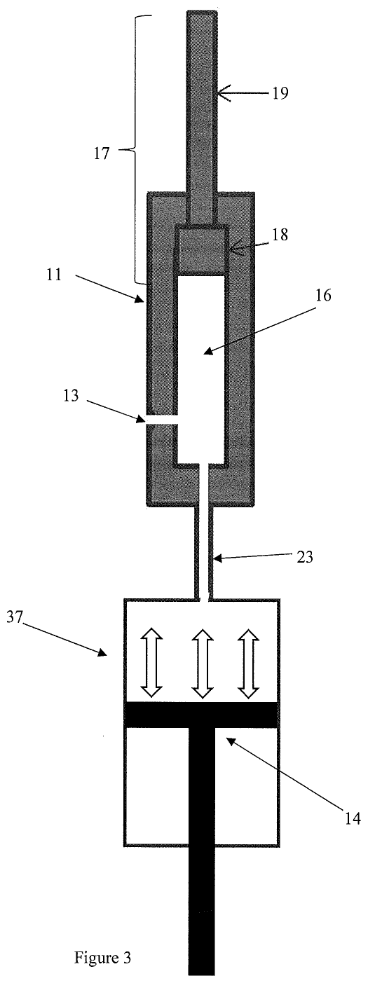

FIG. 3 is a schematic sectional side view of an apparatus according to a third embodiment.

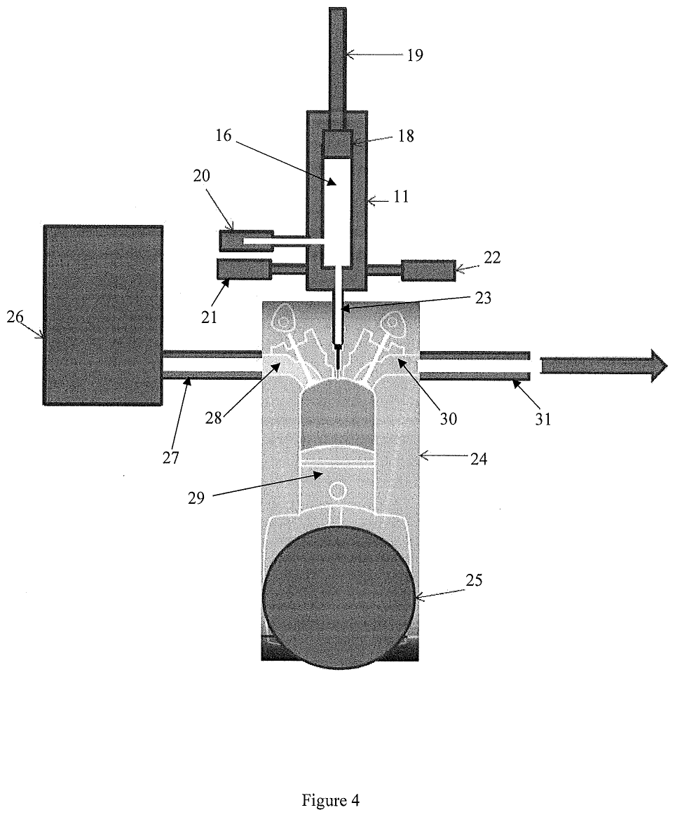

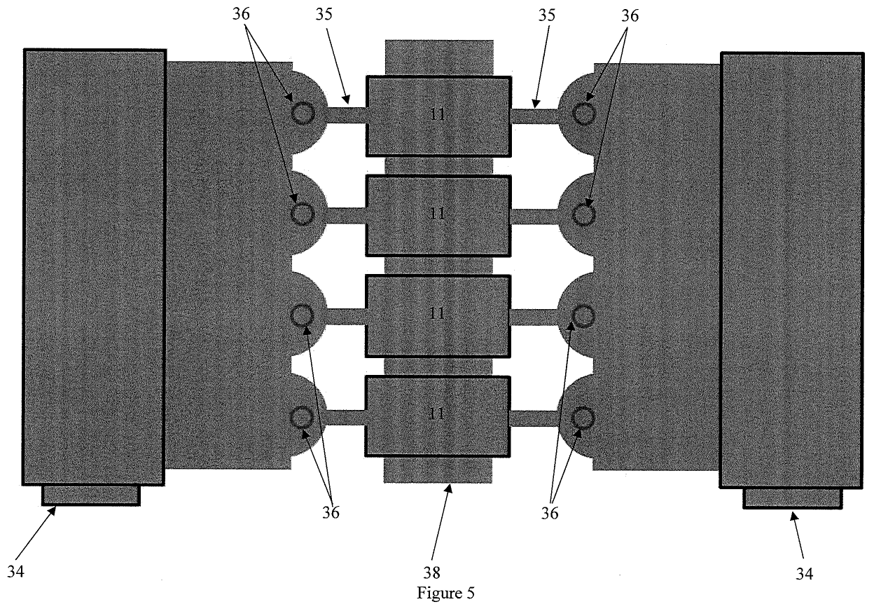

FIG. 4 is a schematic sectional side view of an apparatus according to a fourth embodiment.

FIG. 5 is a schematic sectional side view of an apparatus according to a fifth embodiment.

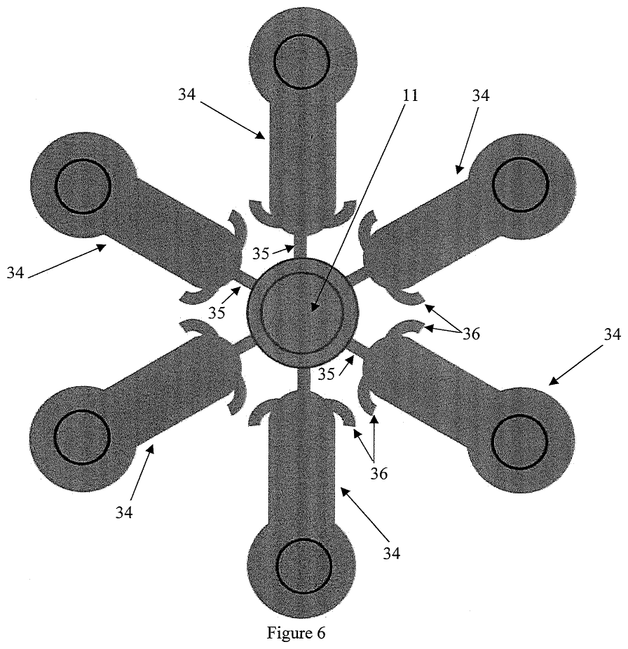

FIG. 6 is a schematic sectional side view of an apparatus according to a sixth embodiment.

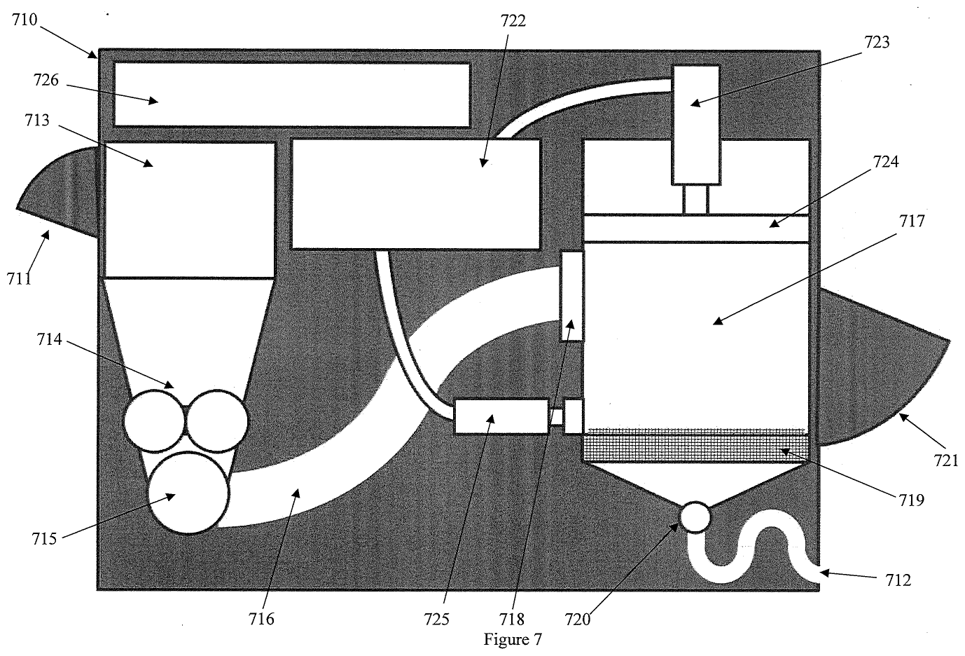

FIG. 7 is a schematic side view of an apparatus according to a seventh embodiment.

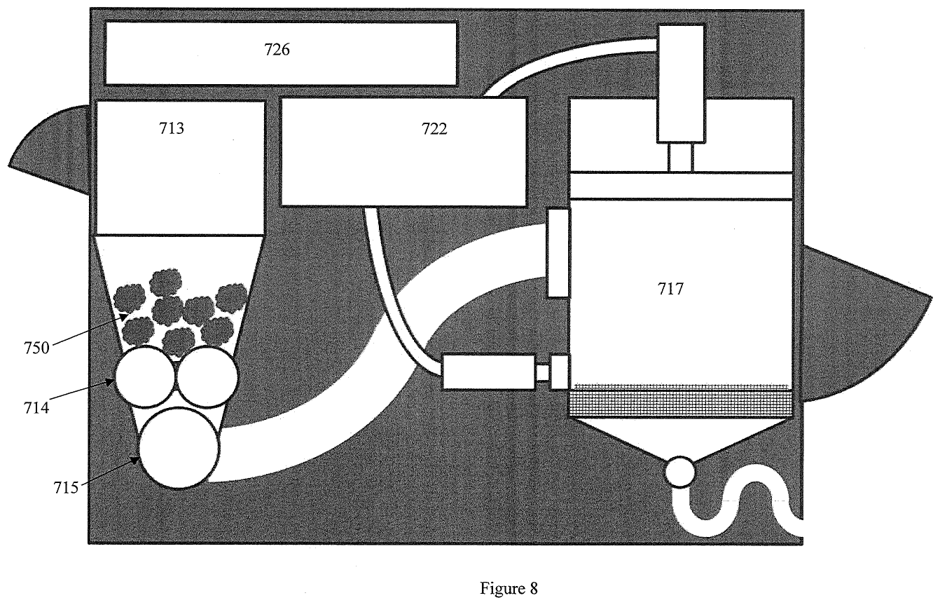

FIG. 8 shows the embodiment illustrated in FIG. 7 with the macerator loaded with a charge of material or product.

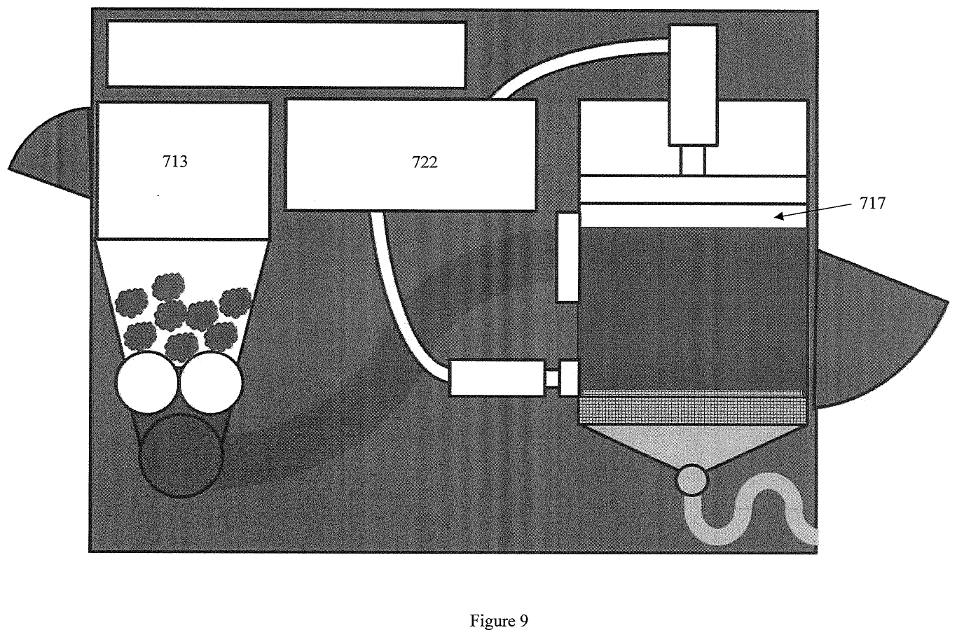

FIG. 9 shows the embodiment illustrated in FIG. 7 with the treatment vessel loaded.

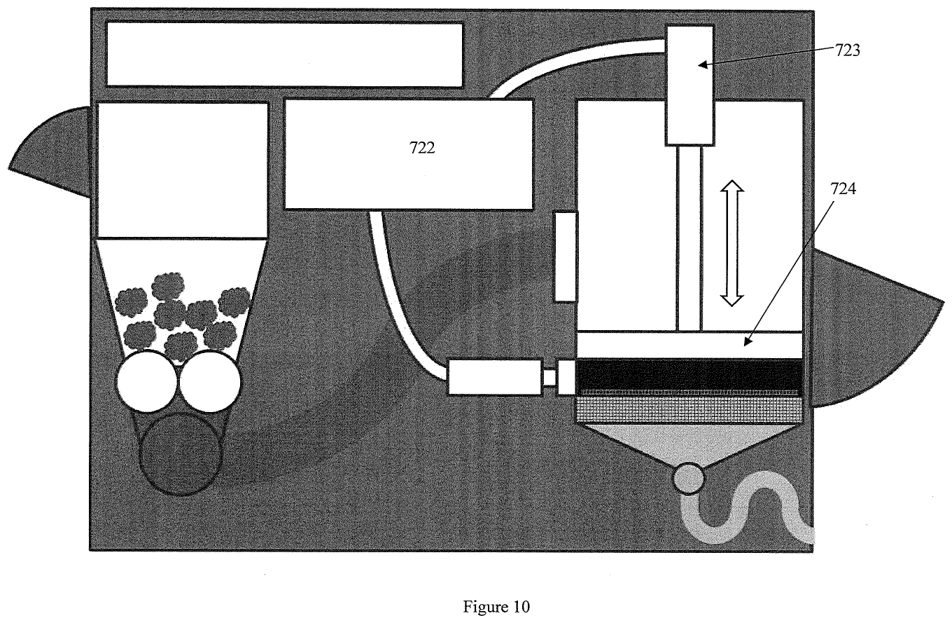

FIG. 10 shows the embodiment illustrated in FIG. 7 with the treatment vessel pressurised.

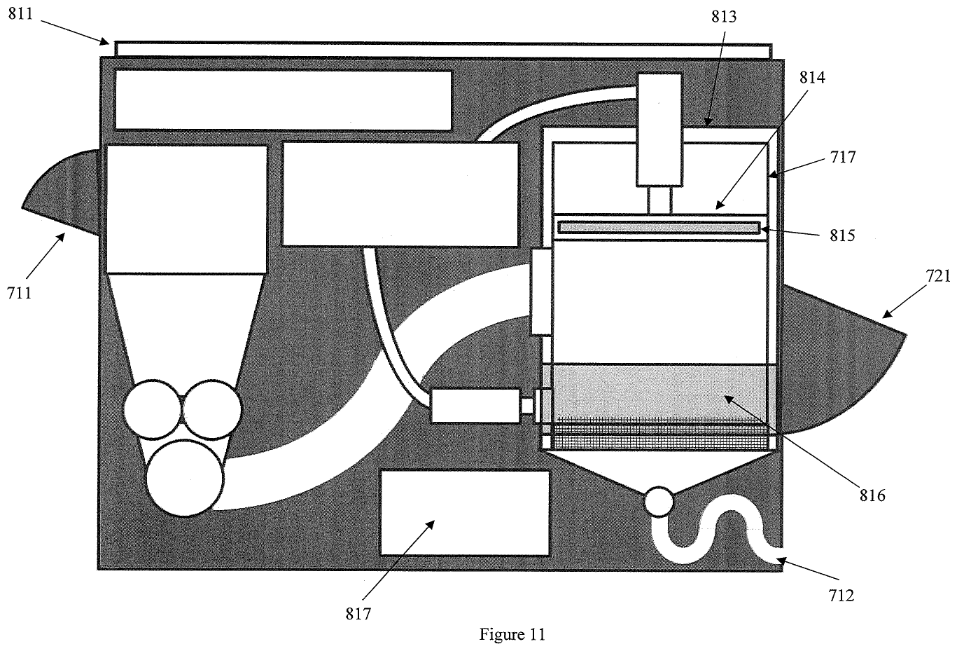

FIG. 11 is a schematic side view of an apparatus according to an eighth embodiment.

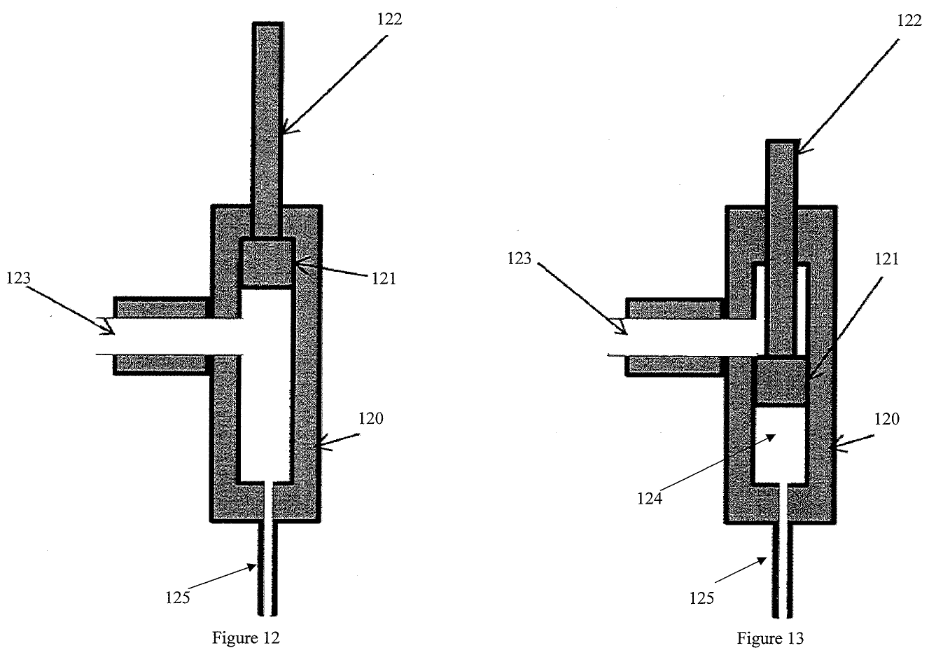

FIG. 12 is a schematic side view of an apparatus according to an alternative embodiment with the piston in the loading position.

FIG. 13 is a schematic side view of the apparatus illustrated in FIG. 12 with the piston in the operational position.

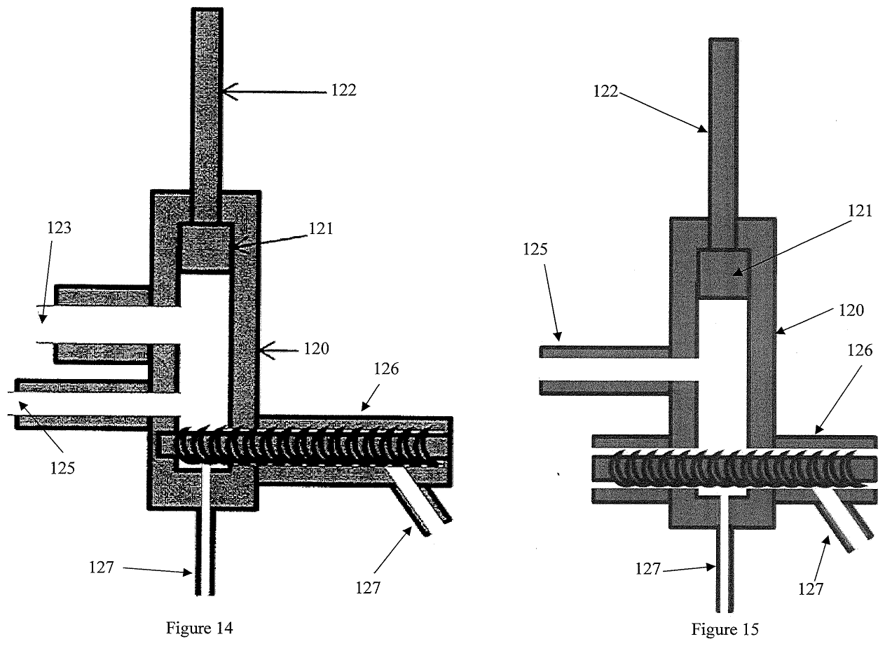

FIG. 14 is a schematic side view of an apparatus according to a further alternative embodiment with a mechanical conveyor to transport material into and out of the treatment vessel.

FIG. 15 is a schematic side view of an apparatus similar to that illustrated in FIG. 14 but of a different configuration.

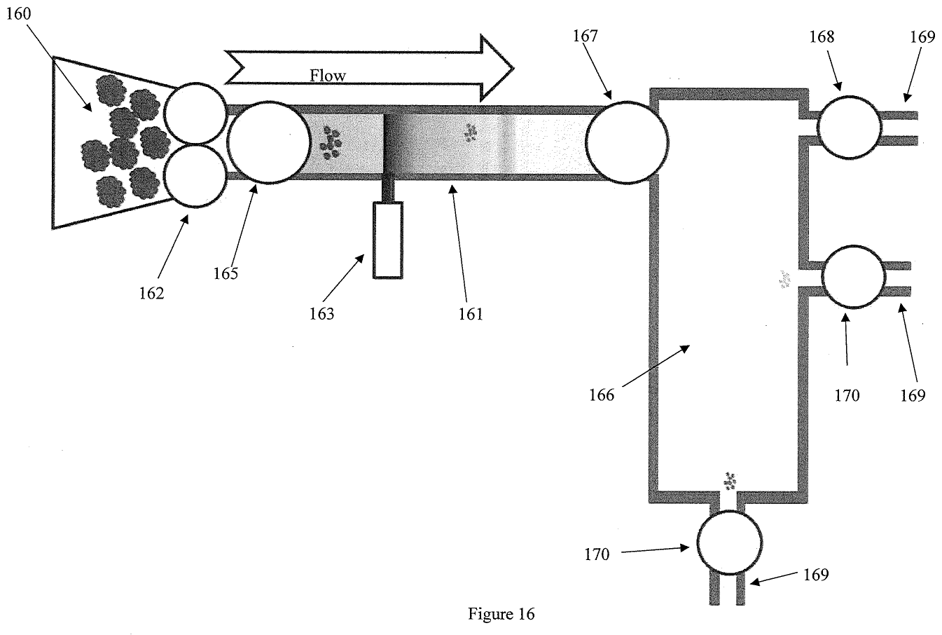

FIG. 16 is a schematic side view of an apparatus according to a further alternative embodiment.

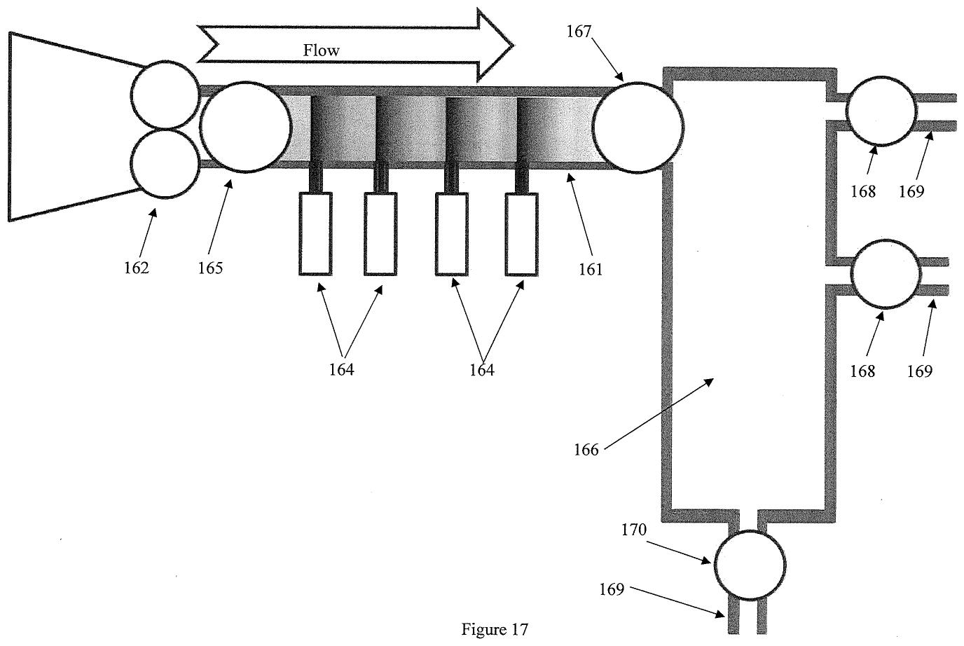

FIG. 17 is a schematic side view of an apparatus according to a further alternative embodiment.

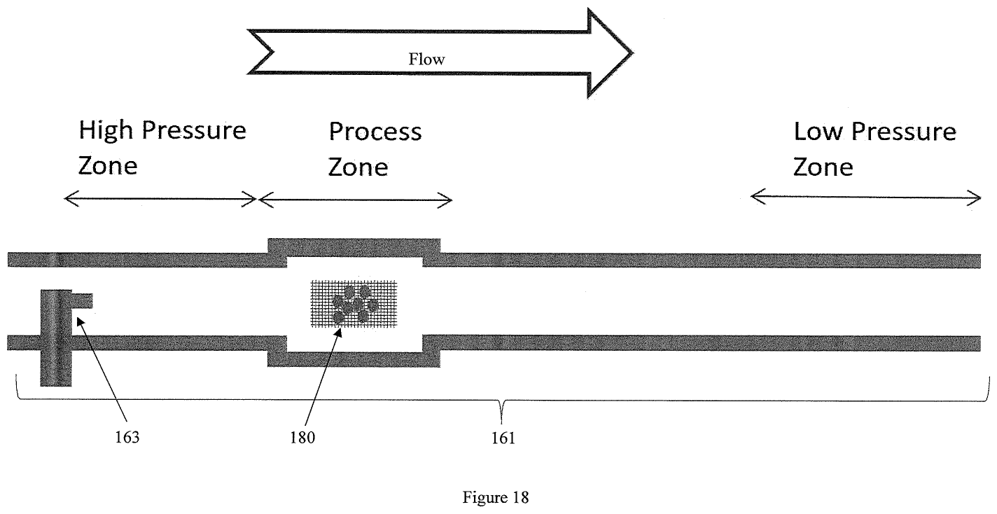

FIG. 18 is a schematic side view of an apparatus according to a further alternative embodiment.

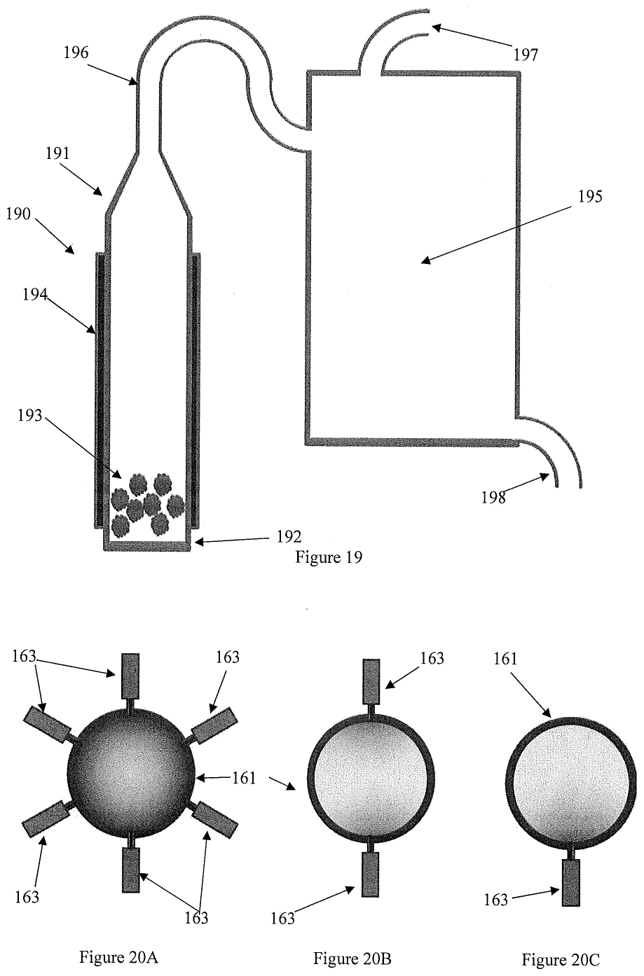

FIG. 19 is a schematic side view of an apparatus according to a further alternative embodiment.

FIG. 20A is a schematic end view of an apparatus showing a possible injector arrangement.

FIG. 20B is a schematic end view of an apparatus showing a second possible injector arrangement.

FIG. 20C is a schematic end view of an apparatus showing a third possible injector arrangement.

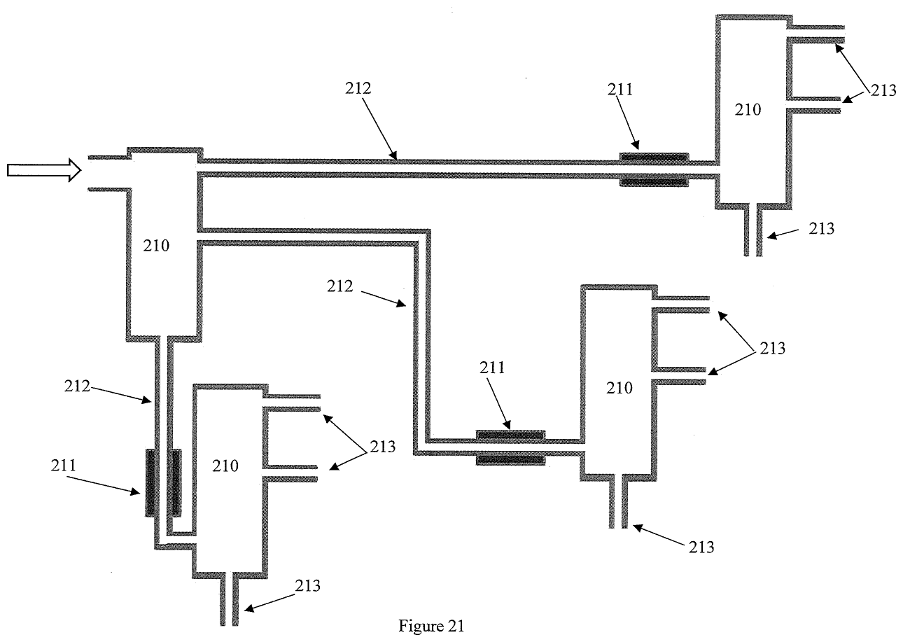

FIG. 21 is a schematic view of a potential downstream separation configuration following an apparatus for the breakdown of one or more materials.

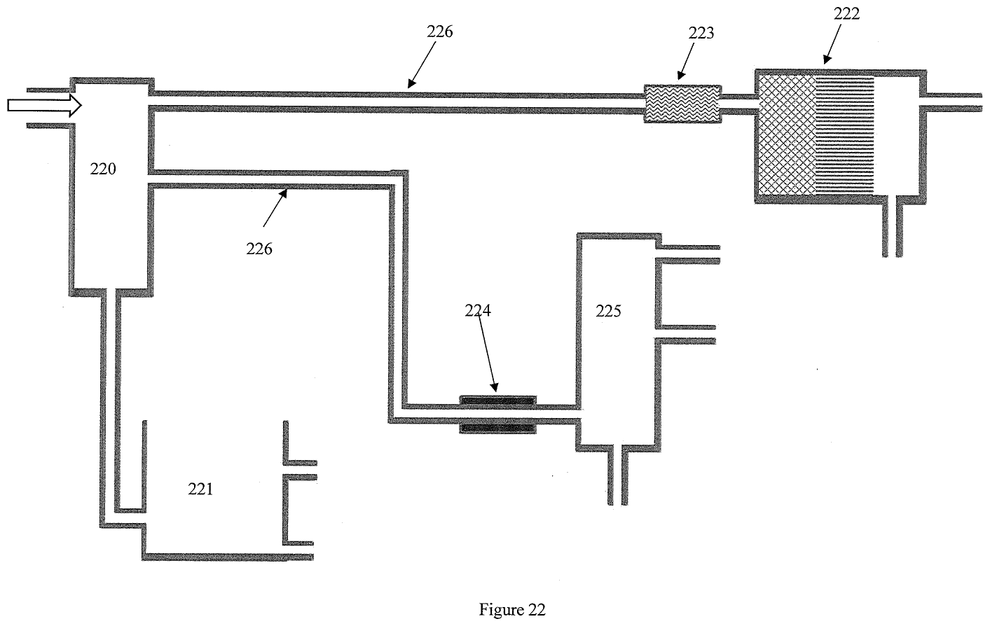

FIG. 22 is a schematic view of a different potential downstream separation following an apparatus for the breakdown of one or more materials.

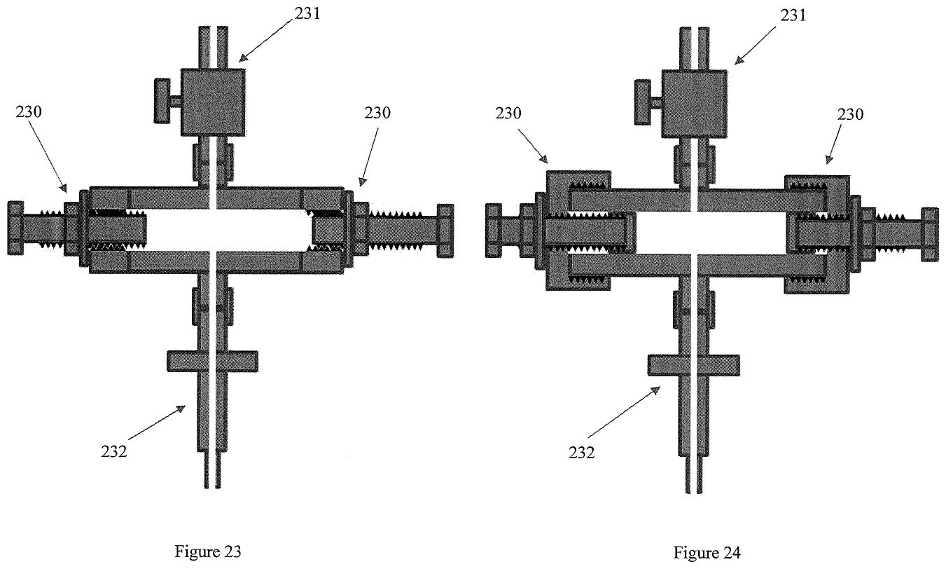

FIG. 23 is a view of a further potential process chamber configuration in an embodiment.

FIG. 24 is a view of another potential process chamber configuration in an embodiment.

In an embodiment of the present invention, an apparatus 10 to effect at least partial breakdown of a material or product item or a combination of material or product items is provided.

A number of embodiments or varying complexity are illustrated in the accompanying Figures.

All illustrated embodiments of the apparatus comprise a treatment vessel 11 into which a material or product item 12 is located and temporarily sealed for treatment. The treatment vessel 11 has an entry 13 for introduction of at least one working fluid. In the embodiments illustrated in FIGS. 1 and 2 in particular, the entry allows for entry of both the material or product item 12 and the at least one working fluid as well as the removal of both.

The treatment vessel 11 is associated with a pressurisation and depressurisation piston 14 to increase pressure within the treatment vessel 11 and then rapidly reduce the pressure in the treatment vessel 11. In use, the pressurisation and depressurisation piston 14 is operable to cause repeated pressurisation and rapid depressurisation within the treatment vessel 11 to effect at least partial breakdown of the material or product item 12.

The apparatus may be implemented in a treatment chamber which is large or small. The embodiments illustrated in FIGS. 1 and 2 are the simplest and smallest embodiments.

The operational parameters of the apparatus will typically be determined according to the material or product item or items to be treated and/or the material or mix if a combination of material or product items is treated.

The treatment vessel may have any configuration. In the embodiments illustrated in FIGS. 1 to 3, the treatment chamber 11 is an elongate chamber. However, these proportions need not be the case and the shape of the chamber will be designed and or adjusted suit the application as required. This treatment chamber will be loaded in any way.

In the stacked embodiment in FIG. 5 and the radial embodiment illustrated in FIGS. 6, the treatment chamber may be cylindrical, or divided into one or more treatment chamber(s), each of which can be acted on by one or more of the six pistons shown. In this embodiment, six treatment chambers may be provided. In FIG. 5, two opposing pistons act on each treatment chamber. Generally, if more than one treatment chamber is provided, then depending upon the configuration the treatment chambers may be opposed to one another to balance the configuration. In this embodiment, the treatment chamber(s) loaded individually or by a carrousel/cassette/pallet system.

Before entry to the treatment vessel, the material or product item or items may be subjected to one or more pre-treatment steps. It is particularly preferred that the material or product item or items undergo size reduction before treatment. Size reduction will typically lead to an increase in surface area per unit volume of the material or product item or items. Surface area of the material or product item or items will typically be an important factor in the efficacy of the treatment with a larger surface area generally leading to greater and/or faster breakdown. Any size reduction mechanism may be used but will typically be appropriate for the type of material or combination of types of material to be treated.

One of the pre-treatment steps may be or include maceration. The liquid used will preferably depend on the composition of the material or to be treated. A pre-treatment step may be used to dehydrate the material and/or pre-soak it in a working fluid that may or may not have active reactive agents within it.

Typically, a batch basis is used for smaller-scale treatment vessels 11 such as those illustrated in FIGS. 1 to 4 but treatment may take place in treatment vessels which operate on a continuous basis or a hybrid basis, such as that illustrated in FIG. 5.

The treatment vessel illustrated in FIG. 1 has a fixed working volume 15.

The treatment vessel illustrated in FIG. 2 is a variable working volume vessel. The working volume 16 of the treatment vessel illustrated in FIG. 2 is adjustable in order to take account of the size of the charge of the material or product item or items and/or the type of material or to be treated. The working volume 16 of the treatment vessel illustrated in FIG. 2 adjusted prior to treatment and then may be maintained as a fixed working volume while a particular treatment regime is underway.

The mechanism illustrated in FIG. 2 for adjusting the working volume 16 is the provision of a piston 17 with a head 18 and a shaft 19 which is movable relative to the working volume 16 of the treatment vessel 11 in order to change the working volume 16. The piston 17 is mounted relative to the treatment vessel 11 using a threaded shaft 19 which has the advantage of being infinitely adjustable. Alternative mechanisms such as a hydraulic ram, pneumatic ram, locking mechanism or a rotating/sliding sheath may be used in place of the threaded shaft.

The piston head 18 is provided least partially within the treatment vessel 11, defining one wall of the working volume 16 allowing the piston head 18 to be moved in the treatment vessel 11 to adjust the working volume 16 of the treatment vessel 11. Reducing the working volume 16 of the treatment vessel 11 may allow higher pressures to be achieved within the treatment vessel.

The material or product item or items are located within the treatment vessel 11 to allow the working fluid access to multiple sides of the material. As illustrated in FIG. 1, the material or product item or items 12 are centrally located within the treatment vessel 11 suspended within the treatment vessel 11. Alternatively, as required by the material and or process, material may be located asymmetrically or free to oscillate.

FIG. 3 is an alternative configuration to that illustrated in FIG. 2. In FIG. 2, both pistons 14 and 17 are in the treatment vessel. In the embodiment illustrated in FIG. 3, the piston 17 that is provided to adjust the size of the working volume 16 is provided in the treatment vessel 11 but the working piston 14 (the piston to increase and decrease the pressure in the treatment vessel to effect treatment of the material or, is provided in a secondary vessel 37 which is spaced from the treatment vessel 11 with the working volume of the secondary vessel 37 linked to the working volume 16 of the treatment vessel 11 via a conduit 23.

The treatment vessel may be connected to allow a portion of the at least one working fluid to bypass part or all of the treatment vessel and/or process and be connected to the outlet of the treatment vessel in order to utilise the Venturi effect or the Bernoulli principle to assist with the removal of the at least one working fluid and/or the at least partially treated material or product item or items from the treatment vessel. A bypass/purge/flush/soak valve 20 is illustrated in FIG. 4.

Monitoring equipment is provided in the embodiment illustrated in FIG. 4 to monitor at least the temperature 21 and pressure 22 within the working volume 16. Typically, monitoring will occur in real-time allowing adjustments to the treatment regime to be made if necessary.

Typically, monitoring, sample testing or the use of one or more indicator devices may be used in real-time or post-process allowing adjustments to the treatment regime to be made if necessary.

Any monitoring, sampling or indicator equipment may be used to monitor the conditions within the treatment vessel, the outside of the treatment vessel and/or one or more exits from the treatment vessel.

The sealing of the treatment vessel may be accomplished in any way that is appropriate and at any time during the operational process that is appropriate. The particular time at which the treatment vessel is sealed will normally depend on whether the treatment vessel is being operated on a batch or continuous basis. The treatment vessel which is being operated on a batch basis will typically be simpler to seal. The time at which the treatment vessel being operated on a batch basis is sealed either prior to introduction of the material or product item or items or thereafter but at least before the introduction of the at least one working fluid into the treatment vessel.

The apparatus of the present invention includes an entry into the treatment vessel for introduction of working fluid. As mentioned above, the embodiments in FIGS. 1 and 2 shows a single entry 13 for both the material or to be treated and the working fluid. This port also allows the removal of the treated product.

The working fluid entry 23 in the embodiment illustrated in FIG. 4 is at one end of the treatment vessel. The entry 23 is associated with a repurposed internal combustion engine 24 with an electric drive motor 25 connected to the engine crank. This configuration can make use of the valve arrangement at an upper portion of the engine to control introduction of the working fluid from the working fluid generator 26 via a supply conduit 27 linked to an inlet port 28 of the engine 24. The reciprocating action of the piston 29 driven by the electric drive motor 25 can then be used to pressurise and depressurise the working volume 16 of the treatment vessel 11 through the entry 23. The outlet port 30 of the engine 24 can be used to exhaust the working fluid when required. The valves associated with the inlet port 28 and the outlet port 30 can be controlled as required according to the operational parameters chosen for the treatment regime. The working fluid, when exhausted, can be vented through conduit 31 or recirculated to the supply conduit 27 with appropriate reconditioning and/or cleaning.

In all illustrated embodiments, a charge of working fluid is introduced into the treatment vessel 11 prior to initialisation of a treatment regime. The size of the charge of the working fluid depends upon the working volume of the treatment vessel and/or on the size of the charge of at least one material or item or items and/or the composition of the material or to be treated. The first pulse from the pressurisation device may be the first introduction of ‘working fluid’—in this case the existing atmosphere in the chamber becomes part of the working fluid mixture.

The configuration illustrated in FIG. 4 in particular allows for additional and/or replacement working fluid to be added to the treatment vessel 11 over the course of the treatment regime.

In the embodiment illustrated in FIGS. 1 and 2, a movable piston 14 with an elongate shaft 32 and an enlarged head 33 is located within the treatment vessel 11 to cause pressure increases within the working volume 15 or 16 of the treatment vessel 11.

The movable piston 14 is mechanically driven (drive not shown but an electric drive motor similar to that illustrated in FIG. 4 can be used) to reciprocate causing the pressurisation and subsequent depressurisation in the treatment vessel 11.

The mechanism used to drive the movable piston is typically used to define the parameters of the pressurisation and depressurisation stages of the cycle according to which the present invention operates.

The pressurisation and depressurisation stages will typically include operational parameters such as the duration of pressurisation, the duration of depressurisation (each of which respectively include both the overall time taken to pressurise and depressurise the treatment vessel as well as the speed of pressurisation and depressurisation), the compression or pressurisation ratio, the depressurisation ratio and the like.

For example, the pressurisation stage may be longer in time than the depressurisation stage which will typically occur rapidly. Alternatively, the pressurisation stage may last substantially the same length of time as the depressurisation stage which will typically occur rapidly.

The depressurisation stage will preferably be a flash or instantaneous depressurisation stage. The increase in pressure may take place over a period of time and then the pressure may be maintained at an elevated level for a period of time within the treatment vessel prior to depressurisation.

A control device will typically be provided to control the mechanism used to drive the movable piston.

The degree of pressurisation and decompression may be the same but implemented over a different time period.

At least one depressurisation mechanism may be provided to rapidly reduce the pressure in the treatment vessel to a pressure of above the starting pressure, that is, the depressurisation mechanism may reduce the pressure in the treatment vessel, but not as much as the immediately preceding increasing pressure.

The degree of pressurisation and depressurisation may differ. The degree of pressurisation and depressurisation may differ in different cycles across the treatment regime. For example, the degree of pressurisation earlier cycles in a treatment regime may be less than the degree of pressurisation in later cycles, in order to build pressure in the treatment vessel and then the later cycles may reduce the pressure in the treatment vessel to a greater degree than the pressurisation in the immediately preceding pressurisation stage.

The at least one pressurisation mechanism will preferably increase the pressure within the treatment vessel by pressurising the working fluid within the treatment vessel. When introduced, the at least one working fluid may displace (totally) any other atmosphere in the treatment vessel or be mixed therewith.

The increasing pressure within the treatment vessel may be a staged increase over a number of cycles, to a maximum treatment pressure, followed by a staged decrease in pressure over a number of cycles.

Preferably, the movable piston 14 and piston 29 will operate to depressurise the treatment vessel 11 using flash decompression or explosive decompression. The at least one depressurisation mechanism may operate more quickly or in a shorter time when compared to the pressurisation stage. It is preferred that the depressurisation stage is substantially instantaneous.

Preferably, the apparatus will be operated in a treatment regime to treat a particular charge of material or, with the treatment regime being made up of a plurality of cycles, each cycle being made up of a pressurisation stage and a subsequent rapid depressurisation stage. The number of cycles in the treatment regime will preferably be determined according to the material or which is introduced for treatment.

The controlling parameters of each pressurisation stage and each subsequent rapid depressurisation stage will normally be determined prior to commencement of the treatment regime or may be adjusted during the treatment regime based upon the measurements, readings or outputs of the process. As mentioned above, the parameters of each pressurisation stage and/or each subsequent rapid depressurisation stage, of each cycle, may be the same or different.

The particular design of the individual stages and the cycles will generally be important to the efficacy (degree of breakdown) and/or efficiency (in terms of time and/or energy used) of the treatment regime.

In a preferred embodiment, the size of the charge of working fluid is adjusted to suit the size of the charge of the material or product item or combination of material or product items and/or the size of the treatment chamber.

The alternative embodiments of the invention illustrated in FIGS. 5 and 6 are simply variations of the number of treatment chambers and the configuration of the movable piston.

In the configuration shown in FIG. 5, a pair of repurposed internal combustion engines 34 capable of moving a number of pistons (obscured within internal combustion engines 34) through rapid compression and decompression cycles. A drive mechanism will normally be provided by an external source such as an electric drive motor similar to that illustrated in FIG. 4. The number of devices and cylinders is for illustration purposes only.

The respective pistons are mounted such that a pipe, manifold, duct, gallery or port 35 links each cylinder of compression/decompression devices to a treatment chamber 11.

The inlet and exhaust manifolds 36 of the repurposed internal combustion engines 34 can be independent or linked. The treatment chamber(s) 11 can be loaded individually or by carrousel/cassette/pallet system 38. The repurposed internal combustion engines 34 can be synchronised using belts, cams, gears, shafts or motor controls.

In FIG. 6, a radial configuration is illustrated. In this configuration, six repurposed internal combustion engines 34 are capable of moving a number of pistons (obscured within internal combustion engines 34) through rapid compression and decompression cycles. A drive mechanism will normally be provided by an external source such as an electric drive motor similar to that illustrated in FIG. 4. The number of devices and cylinders is for illustration purposes only.

The respective pistons are mounted such that a pipe, duct, gallery or port 35 links each cylinder of compression/decompression devices to a central treatment chamber 11. The treatment chamber 11 can be loaded individually or by carrousel/cassette/pallet system.

The inlet and exhaust manifolds 36 of the repurposed internal combustion engines 34 can be independent or linked. The repurposed internal combustion engines 34 can be synchronised using belts, cams, gears, shafts or motor controls.

FIG. 7 shows yet a further embodiment to treat material or such as nappies and sanitary napkins and towels which are difficult to treat using conventional apparatus.

The embodiment of FIG. 7 includes an outer housing 710 with a wet material or load door 711, a foul water drain 712 and a cake unloading door 721. The embodiment is configured to treat material or 750 such as nappies and sanitary napkins and towels which are loaded into a loading chamber 713 located above a macerator 714. The macerator operates to undertake partial deconstruction or chopping of the nappies and sanitary napkins and towels in a liquid, typically water, may be added to the macerator 714. This is shown in FIG. 8.

Once the incoming material or has been macerated, a slurry pump 715 located beneath the macerator 714 then transfers the slurry via a slurry transfer duct 716 to the treatment chamber 717. A valve 718 may be located at the entry to the treatment vessel prevents backflow and seals the treatment vessel 717. Alternatively, the inlet may be arranged in relation to the pressurisation arrangement in a manner that there is no backpressure in the feed duct. FIG. 9 shows the treatment vessel 717 charged with slurry to be treated and the valve closed 718.

The treatment vessel 717 is provided with a perforated bed 719 at a lower side with one or more sheets of filter paper or gauze thereover to minimise clogging of the perforated bed 719. The lower portion of the treatment vessel 717 is shaped to drain fluid into an optional pump 720 which then leads to the foul water drain 712.

A hydraulic package 722 provides hydraulic fluid to drive a ram 723 which in turn, drives the main piston to pressurise the atmosphere within the treatment vessel 717, from the position illustrated generally in FIG. 9 and the position illustrated in FIG. 10, and to depressurise the atmosphere within the treatment vessel 717 repeatedly. The pressurised condition is illustrated in FIG. 10.

The apparatus illustrated will be operated through a treatment regime to at least partial break down the nappies and sanitary napkins and towels and ultimately, the formation of a cake (not illustrated) on the perforated bed 719. At the end of the treatment regime in this embodiment, the final stage will be a compression stage to form the cake which will in turn, force the liquid from the slurry through the perforated bed 719 and dewater the cake as much as possible.

The cake can then be removed from the treatment vessel 717 by the ejector ram 725 also driven by the hydraulic package 722 which will move the cake out of the vessel 717 through the cake unloading door 721. The ejected cake may be bagged at or after exiting the cake unloading door 721.

The configuration is controlled via controller 726.

FIG. 11 shows yet a further embodiment which is similar to that shown in FIG. 7 but is a heated configuration. The components of this embodiment are the same as the embodiment illustrated in FIG. 7 except for some notable additions. Firstly, a renewable power supply generator is associated with the housing 710. In the illustrated embodiment, a solar panel 811 with a tilt or tracking mechanism is provided but a wind turbine or similar can be provided alternatively.

The treatment vessel 717 is provided with a concentric outer chamber 813 to capture vapour and drain condensate. The main piston 814 is provided with an integrated heating element 815. A heating jacket 816 is provided about a lower portion of the treatment vessel 717, however heating jackets or internal elements may be positioned in a variety of locations in and around 813 and or 717 to achieve the required process parameters. A battery array 817 which stores a portion of the electrical charge from the solar panel 811 and powers or contributes toward powering the apparatus is also provided.

The embodiment illustrated in FIGS. 12 and 13 includes a treatment vessel 120 with a piston 121 provided within the vessel to vary the working volume of the vessel. The piston 121 is mounted on a control rod 122 associated with a control mechanism to adjust the size of the treatment chamber. In FIG. 12, the piston is illustrated in a raised position to allow material input and output through the material port 123. The pressurisation/depressurisation port 125 is shown at a lower portion of the treatment vessel 120. In FIG. 13, the piston has been moved to the operational position, which defines the volume of the treatment chamber 124. Movement of the piston 121 also seals the treatment chamber 124 (as it is positioned below the material port 123).

FIG. 14 shows an alternative configuration with similar features to the previous embodiments. The treatment vessel 120 is provided with a piston 121 provided within the vessel to vary the working volume of the vessel. The piston 121 is mounted on a control rod 122 associated with a control mechanism to adjust the size of the treatment chamber. A material port 123 is provided. The pressurisation/depressurisation port 125 of this embodiment is provided adjacent to the. material port 123. A conveying mechanism, which in this embodiment is a screw conveyor 126 is provided at a lower side of the treatment vessel 120 to either transport material for treatment into the treatment vessel 120 and/or to remove treated material from the treatment vessel 120 or perform both functions whilst also sealing the treatment vessel 120. Optional drains or ports 127 are provided for removal of material at different locations relative to the screw conveyor.

The embodiment illustrated in FIG. 15 is similar to that illustrated in FIG. 14. In both configurations, a screw conveyor 126 is provided in a lower portion of the treatment vessel 120 to convey treated material in and/or out of the treatment vessel. A screw conveyor 126 can seal the exit from the treatment vessel through the formation of a plug of material in the screw conveyor. A screw conveyor 126 may extend into the treatment vessel and may simply remove material with a separate inlet portion 123 for locating the material within the treatment vessel. The material once removed can be separate into one or more exit ports 127.

FIG. 15 shows an alternative configuration in which the screw conveyor 126 is provided through the treatment vessel 120 which allows the screw conveyor 126 to convey material to be treated into the treatment vessel 120, support the material during treatment and then remove material from the treatment vessel.

In either case, the screw conveyor 126 may rotate in a single direction only at all times or in a first direction to input material and an opposite direction to remove material.

FIG. 16 is a schematic side view of an apparatus according to a further alternative embodiment which is capable of operating in a continuous or batch mode. The material 160 to be treated (or a mixture containing one or more materials to be treated) is introduced into an elongate treatment vessel in the form of a treatment duct 161 in which the pressurisation and depressurisation takes place.

The material to be treated (or a mixture containing one or more materials to be treated) is preferably conveyed longitudinally through the treatment duct 161 during treatment. A process device 165 such as an impellor, pump, fluid jet, or the like is shown at the inlet end of the treatment duct 161 to create the flow in desired direction of the material to be treated, in the direction of the arrow. The material may be fluidised using working fluid.

A macerator 162 or any other appropriate pre-treatment process equipment may be provided at the inlet end of the treatment duct 161 for preparing workpieces/material to an appropriate particle size/shape/state for treatment.

In the embodiment illustrated in FIG. 16, pressurisation of the material to be treated (or a mixture containing one or more materials to be treated) occurs through the application of pressure using an injector 163 to create one or more zones of elevated pressure within the treatment duct 161 in which pressurisation of the material to be treated takes place. Depressurisation occurs when the injectors 163 ceases to apply pressure and/or when the flow of material to be treated (or a mixture containing one or more materials to be treated) through the treatment duct, moves the material to be treated (or a mixture containing one or more materials to be treated) out of the elevated pressure zone created by the injector. The injector 163 illustrated in FIG. 16 may be associated with a reservoir of pressurised working fluid in order to apply the pressure.

Preferably, high pressure working fluid is introduced in one or more pulse(s) via the injector 163 so as to rapidly pressurise immediate zone of treatment duct 161. There may be multiple pulses from one or more injector(s) provided in a single phase or stage or multiple phases or stages of injectors 164 may be used as shown in FIG. 17. Pressurisation may be achieved within the injector or prior to injector feed. Depressurisation is achieved as a result of absence of injector pulse.

The pressure may be applied in one or more pulses through an injector 163. Multiple injectors may be provided radially or circumferentially about the treatment duct, provided in the same plane as a single stage or phase. Multiple injectors may be provided over the length of the treatment duct as shown in FIG. 17, in multiple phases or stages of injectors 164.

High pressure working fluid may be introduced in pulse(s) via one or more injectors so as to rapidly pressurise a zone in the treatment duct 161. There may be multiple pulses from single phase or stage of injector(s) 163 or multiple phases or stages of injectors 164. Pressurisation of the working fluid may be achieved within the injector or prior to the injector feed using pressurised working fluid stored in a reservoir for example. Depressurisation can be achieved as a result of absence of the injector pulse.

The injector 163 in FIG. 16 (and the multiple injectors 164 in FIG. 17) is illustrated provided substantially transverse to the direction of the flow through the treatment duct 161.

The number and configuration of injector(s) 163 or 164 provide will depend on the treatment regime required. A ring of multiple injectors about the treatment duct 161 can create a treatment zone through which the material must pass. An example of this configuration is show in FIG. 20A.A pair of opposed injectors as shown in FIG. 20B could be used or a single injector as shown in FIG. 20C. The duct cross-section shape and number of injectors and orientation can be varied to accommodate material breakdown requirements, process capacity requirements, assembly constraints, cost, and the like.

As shown in FIG. 17, Multiple rings of multiple injectors over the length of the treatment duct 161can form multiple treatment zones over the length of the treatment duct 161.

In FIG. 16, a low-pressure chamber/zone 166 with passive or active separation for example fractional distillation, electrostatic/electromagnetic separation, cyclonic/inertial filtration is provided at the outlet end of the treatment duct 161. A flow control device 167 may be provided between the outlet end of the treatment duct 161 and the low-pressure chamber/zone 166.

The working fluid may be pumped out of the low-pressure chamber/zone 166 with flow from the low-pressure chamber/zone 166 may be controlled using a flow control device 168. This may also simply be vented to atmosphere or a fluid reservoir.

Single or multiple exit ports 169 may be provided for separated component/material/catalyst extraction, again with or without flow controlled using a flow control device 170. Additional downstream stages of separation can be added as required with optional configurations illustrated in FIGS. 21 and 22.

As illustrated in FIG. 18, one or more injectors may be provided in line within the treatment duct. This can create a pulsej et-configuration treatment duct with a high-pressure zone, a process zone and a low-pressure zone as illustrated. The pulsejet configuration may or may not involve combustion. In this configuration, treatment will normally be intermittent, with the pressurisation and expulsion of each charge of working fluid or mixture (material to be treated and working fluid) preferably causing the intake of a fresh charge of working fluid or material to be treated and working fluid. The material to be treated 180 may also be loaded and secured within the process zone of the duct during its treatment.

A low-pressure zone or vessel may be associated with an outlet of a treatment duct or vessel. The low-pressure zone or vessel may be at or close to a vacuum.

FIG. 19 is a schematic side view of an apparatus according to a further alternative embodiment. In this configuration, a two-part treatment vessel 190 with either an upper removable cap 191 or removable base 192 in order to load material to be treated. Material 193 to be treated is loaded into the treatment vessel 190 for treatment.

In the configuration illustrated in FIG. 19, an arrangement of one or more heating elements mechanisms around/through chamber/vessel/zone are illustrated to achieve variations in temperature (and via temperature, changes in pressure to achieve pressurisation and depressurisation in working fluid atmosphere above/surrounding material 193 to be treated. The heat may be provided through direct or indirect heating of material and/or working fluid.

A low-pressure zone or vessel and/or low-temperature zone or vessel 195 may be associated with an outlet 196 of a treatment vessel. An upper conduit 197 and a lower outlet 198 are provided from the vessel 195. The upper conduit 197 may be a cold fluid inlet and mist or alternative means of reducing pressure within vessel 195. The lower outlet 198 may be form removal of working fluid and/or broken-down material. Material, broken down components and working fluid will typically experience variations in pressure and temperature as they progress through zones of the equipment illustrated in FIG. 19.

As mentioned above, FIGS. 21 and 22 each show a schematic view of a potential downstream separation configuration following an apparatus for the breakdown of one or more materials. The number and type of stages/separation used will be primarily dictated by purification requirements of working fluid(s)/catalyst(s)/component(s)/material(s). In FIG. 21, any mixture exiting the treatment vessel will typically enter the downstream separation area and travel through any one or more separation process vessels 210. Heating and/or cooling 211 may be provided in any one or more of the separation process vessels 210 and/or any one or more of the linking conduits 212 as shown. Each separation process vessel may include one or more exit ports 213 for separated component/material/catalyst extraction. Additional downstream stages of separation added as required.

A more particular downstream separation area is illustrated in FIG. 22. A balancing vessel 220 is preferably provided for any mixture exiting the treatment vessel. In the illustrated embodiment, a settlement tank 221 is provided with an upper and lower exit therefrom. An electrostatic precipitator 222 with a pair of outlet portions therefrom is included with a mechanical filtration stage 223, typically a mesh or gauze filter included prior to the electrostatic precipitator 222. A further separation process vessel 225 is provided. Again, heating and/or cooling 224 may be provided in any one or more of the separation process vessels and/or any one or more of the linking conduits 226 as shown.

In FIGS. 23 and 24, two additional potential process chamber configurations are shown. In these Figures, dual arrangements 230 to provide material loading and volume variation are shown in two different arrangements, relative to a treatment vessel that also includes a bypass/purge valve 231 and a pressurisation/depressurisation port 232. The threaded arrangements illustrated in FIGS. 23 and 24 provide fine adjustment capability, which may not be achievable with a piston arrangement.

Embodiments of the present invention can be optimised to treat waste such as carpet, plastic bottles, containers, bags and other plastic products, fashion items, nappies and other absorbent products as well as other items that have waste material on/in them such as diesel particulate filters, cleaning engines, components, material from pipes or conduits, treating/recovery of carbon fibre, fibreglass, phenolic resin, and/or removal of moulding material.

The one or more embodiments are described above by way of example only. Many variations are possible without departing from the scope of protection afforded by the appended claims.

1. An apparatus to effect at least partial breakdown of a material or product item or a combination of material or product items, the apparatus comprising:
at least one treatment vessel in which the material or product item or combination of material or product items are located for treatment;
at least one entry into the at least one treatment vessel for introduction of at least one working fluid;
at least one pressurisation arrangement to increase pressure on the material or product item or combination of material or product items in the treatment vessel within the at least one treatment vessel; and
wherein the at least one pressurisation arrangement is operable to cause repeated pressurisation and rapid depressurisation on the material or product item or combination of material or product items in the treatment vessel within the at least one treatment vessel.

2. An apparatus as claimed in claim 1 wherein any parameters for operation of the apparatus are determined according to material or product item or a combination of material or product items to be treated.

3. An apparatus as claimed in any one of the preceding claims wherein the treatment vessel has a working volume which is variable in size.

4. An apparatus as claimed in claim 3 further comprising a piston mechanism which is movable relative to the working volume of the treatment vessel in order to change the working volume.

5. An apparatus as claimed in claim 3 or claim 4 wherein the working volume of the treatment vessel is adjusted prior to treatment and remains fixed during a treatment regime.

6. An apparatus as claimed in any one of the preceding claims further comprising a mount to locate the material or product item or a combination of material or product items within the treatment vessel to allow the at least one working fluid access to multiple sides of the material or product item or a combination of material or product items.

7. An apparatus as claimed in any one of the preceding claims further comprising at least one recycle line to recycle of at least part of the at least one working fluid.

8. An apparatus as claimed in any one of the preceding claims further comprising at least one bypass, purge or exit arrangement connected to an outlet of the treatment vessel to allow a portion of the at least one working fluid to bypass, purge or exit the treatment vessel without being subject to the full process cycle or undergoing full pressurisation and/or depressurisation.

9. An apparatus as claimed in any one of the preceding claims further comprising monitoring equipment associated with the treatment vessel to monitor and/or control one or more conditions within the treatment vessel.

10. An apparatus as claimed in any one of the preceding claims further comprising at least one inlet for each of the material or product item or combination of material or product items and the at least one working fluid is provided.

11. An apparatus as claimed in any one of the preceding claims further comprising at least one outlet for each of the at least one working fluid and the treated material or product item or combination of material or product items, is provided.

12. An apparatus as claimed in any one of the preceding claims wherein a single arrangement or mechanism is provided to cause pressurisation and depressurisation.

13. An apparatus as claimed in any one of the preceding claims wherein a movable piston is associated with the treatment vessel to cause pressure increases within the working volume of the treatment vessel.

14. An apparatus as claimed in claim 13 wherein the movable piston is located at least partially within the treatment vessel.

15. An apparatus as claimed in claim 13 wherein the movable piston is located within a secondary vessel associated with the treatment vessel to allow the moveable piston to cause pressure increases within the treatment vessel.

16. An apparatus as claimed in claim 13 wherein the movable piston is located within a secondary portion of the treatment vessel which is separated from a treatment portion of the treatment vessel into which the material or product item or combination of material or product items is introduced, the secondary portion associated with the treatment portion such that an increase in pressure in the secondary portion also causes an increase in pressure in the treatment portion.

17. An apparatus as claimed in any one of claims 13 to 15 wherein the movable piston is reciprocated causing the pressurisation and subsequent rapid depressurisation in the treatment vessel.

18. An apparatus as claimed in any one of the preceding claims comprising a repurposed internal combustion engine to cause the pressurisation and subsequent rapid depressurisation in the treatment vessel.

19. An apparatus as claimed in any one of the preceding claims further comprising a controller provided to control the at least one pressurisation arrangement or mechanism and at least one depressurisation arrangement or mechanism to define one or more operational parameters of the increase in pressure and depressurisation.

20. An apparatus as claimed in any one of the preceding claims wherein the at least one depressurisation mechanism is a flash decompression or explosive decompression arrangement or mechanism.

21. An apparatus as claimed in any one of the preceding claims further comprising an agitator associated with the treatment vessel to agitate or circulate the at least one working fluid within the treatment vessel.

22. An apparatus as claimed in any one of the preceding claims wherein the at least one working fluid is gaseous.

23. An apparatus as claimed in any one of the preceding claims wherein the at least one working fluid comprises a mixture of phases.

24. An apparatus as claimed in any one of the preceding claims wherein the at least one working fluid comprises a mixture of materials.

25. An apparatus as claimed in any one of the preceding claims wherein the at least one working fluid comprises at least one active component and at least one carrier.

26. An apparatus as claimed in claim 25 wherein the at least one active component comprises one or more reactant and/or one or more solvent.

27. An apparatus as claimed in claim 25 or claim 26 wherein the at least one active component comprises one or more volatile substances.

28. An apparatus as claimed in any one of claims 1 to 12 wherein a movable mechanism is associated with the treatment vessel to cause pressure increases within the working volume of the treatment vessel.

29. An apparatus as claimed in any one of the preceding claims wherein the pressure increases within the working volume of the treatment vessel are created through the application of heat.

30. An apparatus as claimed in any one of the preceding claims wherein treatment occurs in an elongate treatment vessel through which the material to be treated is conveyed during treatment.

31. An apparatus as claimed in any one of the preceding claims wherein the pressure increases in the treatment vessel are created in one or more elevated pressure zones in the treatment vessel using at least one injector, in at least one pulse.

32. An apparatus as claimed in claim 31 wherein the depressurisation occurs through the absence of pressure as material moves out of the one or more elevated pressure zones or ceasing of the at least one pulse.

33. An apparatus as claimed in either one of claim 31 or claim 32 wherein the at least one injector is oriented radially into the treatment vessel.

34. An apparatus as claimed in either one of claim 31 or claim 32 wherein the at least one injector is provided inline with the treatment vessel to create a pulsej et effect.

35. An apparatus as claimed in claim 33 wherein multiple injectors are provided in a single stage.

36. An apparatus as claimed in claim 33 or claim 35 wherein multiple injectors are provided in a single stage and multiple stages of injectors are provided over a length of the treatment vessel.

37. An apparatus as claimed in any one of the preceding claims further comprising at least one depressurisation arrangement or mechanism to rapidly reduce the pressure in the at least one treatment vessel and wherein the at least one pressurisation arrangement or mechanism and the at least one depressurisation arrangement or mechanism are operable to cause repeated pressurisation and rapid depressurisation within the at least one treatment vessel.

38. An apparatus as claimed in any one of the preceding claims wherein the at least one catalyst is included in the treatment.

39. An apparatus as claimed in any one of the preceding claims wherein any pressure decreases within the working volume of the treatment vessel are created through the removal of heat.
